(19) United States
(12) Patent Application Publication
(10) Pub. No.: US 2024/0184976 A1
(43) Pub. Date: Jun. 6, 2024

(54) VISUALIZING DOCUMENT ANNOTATIONS IN THE CONTEXT OF THE SOURCE APPLICATION

(71) Applicant: Saudi Arabian Oil Company, Dhahran (SA)

(72) Inventors: Amal M. Maawadh, Dhahran (SA); Nayif Ghamdi, Dhahran (SA)

(21) Appl. No.: 18/075,038

(22) Filed: Dec. 5, 2022

(51) Int. Cl. G06F 40/169; G06F 16/176

(52) U.S. Cl. CPC G06F 40/169; G06F 16/176

(57) ABSTRACT

Systems and methods include a computer-implemented method for handling collaboration and providing visualizations of annotations in a formatted document linked to a source application. One or more copies of a formatted file are generated by a document visualization/collaboration system (DVCS) from a source document. Each copy has an exported document format and contains content from the source document. A determination is made by the DVCS that annotations made by collaborators exist in respective copies of the one or more copies of the formatted file. The annotations are imported by the DVCS. Each annotation includes a name of a collaborator and a positional tag identifying a position in the collaborator's respective copy of the formatted file.

### TECHNICAL FIELD

The present disclosure applies to reviewing and collaborating on content.

### BACKGROUND

A source document that is to be reviewed can be circulated to multiple users in a portable document format (PDF) file. Users (e.g., reviewers) can manually annotate their copies of the PDF. Conventional systems require that annotated PDF copies be collected and that the initiator of the source document manually review the annotations and comments in each reviewers PDF, from which the source document is manually updated. This can be a time-intensive process, especially when the PDF document exported from the source application consists of a large number of pages and/or there are many reviewers of the document.

### SUMMARY

The present disclosure describes techniques that can be used for handling collaboration and providing visualizations of annotations in a formatted document linked to a source application. In some implementations, a computer-implemented method includes the following. One or more copies of a formatted file are generated by a document visualization/collaboration system (DVCS) from a source document. Each copy has an exported document format and contains content from the source document. A determination is made by the DVCS that annotations made by collaborators exist in respective copies of the one or more copies of the formatted file. The annotations are imported by the DVCS. Each annotation includes a name of a collaborator and a positional tag identifying a position in the collaborator's respective copy of the formatted file.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. Information entered in an application (e.g., a Service Review Committee (SRC) application) by an initiator needs to be reviewed by many users (e.g., in a portable document format (PDF)) and updated in the source application based on feedback received from the reviewers. Techniques of the present disclosure solve the technical problem of review and update, and further reduce time and effort spent reflecting changes from PDF reviews and manually updating the source application. For example, annotations made by reviewers and captured from multiple PDFs of the source document can be automatically collected and visualized by the initiator in the source application. Although limited-function PDF generation and PDF collaboration review applications are available, PDF annotation linkages to the source application are not. Techniques of the present disclosure provide end users with a time- and effort-saving approach that is not available in other commercial alternatives. Comments made by reviewers can be reflected in the source document in real-time. The term real-time can correspond, for example, to events that occur within a specified period of time, such as within one second. Reviewers are provided with simultaneous display access to review comments and annotations. Reviewers can comment on and reply to others' comments when in the review session. Another advantage is the ability to conduct multiple review sessions on the same item where the comments from each session are saved as a version in PDF format for future reference.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a flow diagram showing an example of a high-level workflow for visualizing annotations in a source application, according to some implementations of the present disclosure.

FIG. 2 is a screen print showing an example of a request initiation screen, according to some implementations of the present disclosure.

FIG. 3 is a screen print showing an example of a request details definition page, according to some implementations of the present disclosure.

FIG. 4 is a screen print showing an example of a facesheet page, according to some implementations of the present disclosure.

FIG. 5 is a screen print showing an example of a plan and bid slate, according to some implementations of the present disclosure.

FIG. 6 is a screen print showing an example of a reviewer selection screen, according to some implementations of the present disclosure.

FIG. 7 is a screen print showing an example of a review sessions selection page, according to some implementations of the present disclosure.

FIG. 8 is a screen print showing an example of a review session screen, according to some implementations of the present disclosure.

FIGS. 9A and 9B collectively show an example of collaboration session screen prints, according to some implementations of the present disclosure.

FIGS. 10A and 10B collectively show an example of collaboration session screen prints, according to some implementations of the present disclosure.

FIG. 11 is a flowchart of an example of a method for handling collaboration and providing visualizations of annotations in a formatted document linked to a source application, according to some implementations of the present disclosure.

FIG. 12 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for handling collaboration and providing visualizations of annotations in a formatted document linked to a source application. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The present disclosure describes techniques for retrieving and visualizing annotations from a portable document format (PDF) document exported from a source application. To perform annotation retrieval, the original application is exported to the PDF, where the process is used to import the text content of the application into exported document format (e.g., a PDF) page. Later, the page number of the exported document is used as a connection or linkage between an annotation position from exported document format and the source application format to which the annotation applies.

A workflow used to visualize annotations captured from multiple copies of document format (PDF) generated from a source application can include the following. A user (e.g., initiator) enters text in a source application. The text entered in the source application is converted/exported to portable document format (PDF) pages. The converted/exported document is made available to other users (e.g., reviewers) in PDF form. The process enables users (reviewers) to view the exported document and select annotations. The process is used to compile annotations from the multiple PDF copies as positional tags per page. The initiator is able to visualize the annotations in the source application interface without the need to open any (e.g., potentially multiple) copies of the PDF document.

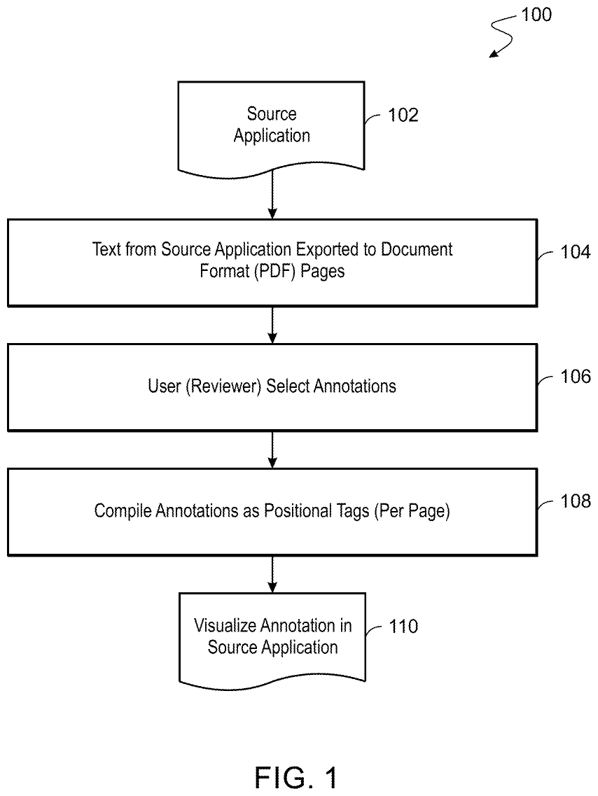

FIG. 1 is a flow diagram showing an example of a high-level workflow 100 for visualizing annotations in a source application 102, according to some implementations of the present disclosure. At 104, text from the source application 102 is exported to a formatted document (e.g., PDF pages). At 106, a user (e.g., acting as a reviewer) selects annotations, e.g., by adding comments to the PDF document and/or by using tools such as highlighters and comment bubbles. At 108, the annotations are compiled as positional tags (per page) from multiple users/reviewers. At 110, the annotations can be presented in a visualization, e.g., to the initiator of the document.

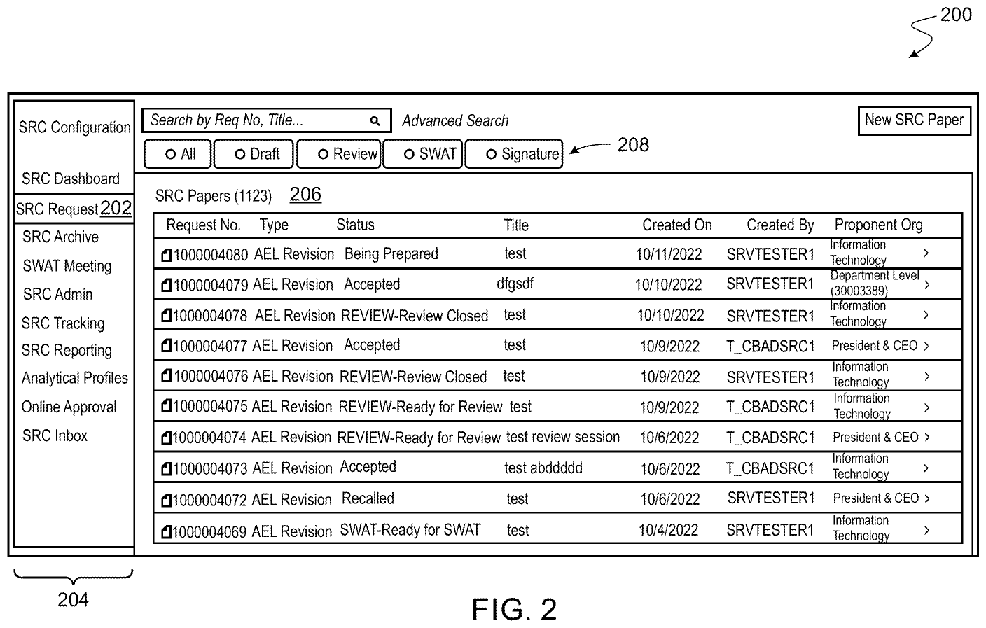

FIG. 2 is a screen print showing an example of a request initiation screen 200, according to some implementations of the present disclosure. For example, an initiator of a request/paper/form can use the request initiation screen 200 to access a source/software application. Initiation can begin by selecting a source request option 202 (e.g., originating from a Service Review Committee (SRC)) option list 204. A display area 206 can display candidate requests from which the initiator can select a specific request. Information displayed in the display area 206 for each candidate request includes at least a request number (No.), a request type, a status, and a title of the request. Filter options 208 allow the initiator to filter the request candidates to be displayed, which can be one or more of draft, review, or Strengths, Weaknesses, Analysis, and Team (SWAT). The main role of the SWAT team is to review requests using a similar approach used in the review session previously described. A difference is that multiple requests can be added to a SWAT meeting and scheduled to be available to SWAT members/reviewers to access and review requests needing signatures. Logic in the source application can automatically cycle requests to new statuses as work is completed on the request.

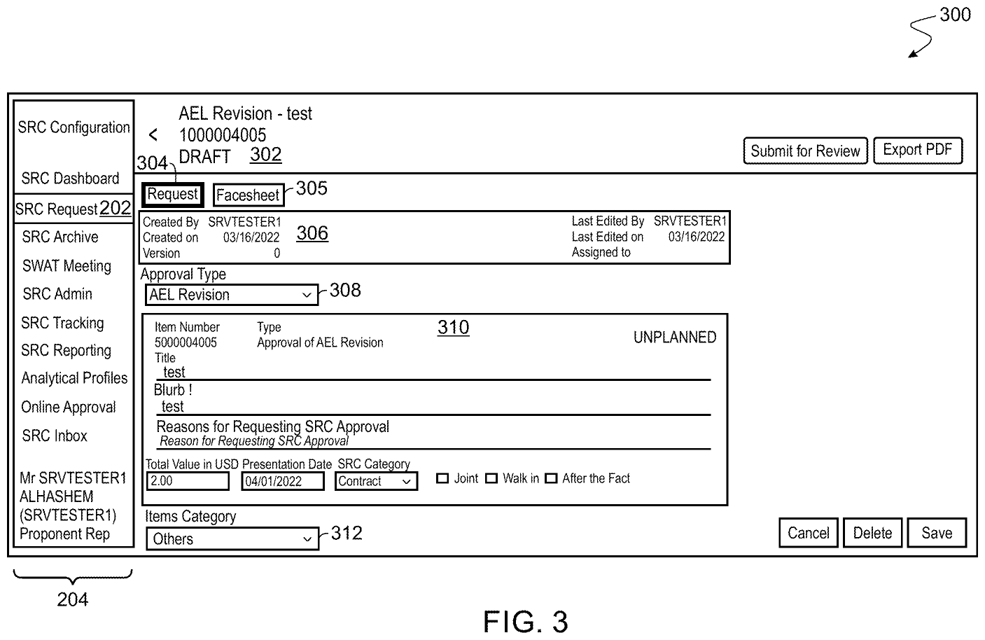

FIG. 3 is a screen print showing an example of a request details definition on page 300, according to some implementations of the present disclosure. The request details screen 300 can be displayed when the initiator creates a new request/paper/form (identified by request number 302) in order to begin filling in the required fields in each tab, automated attachment, and automated exhibit. The information displayed in FIG. 3 is a request information definition page that is displayed since a request tab 304 is active.

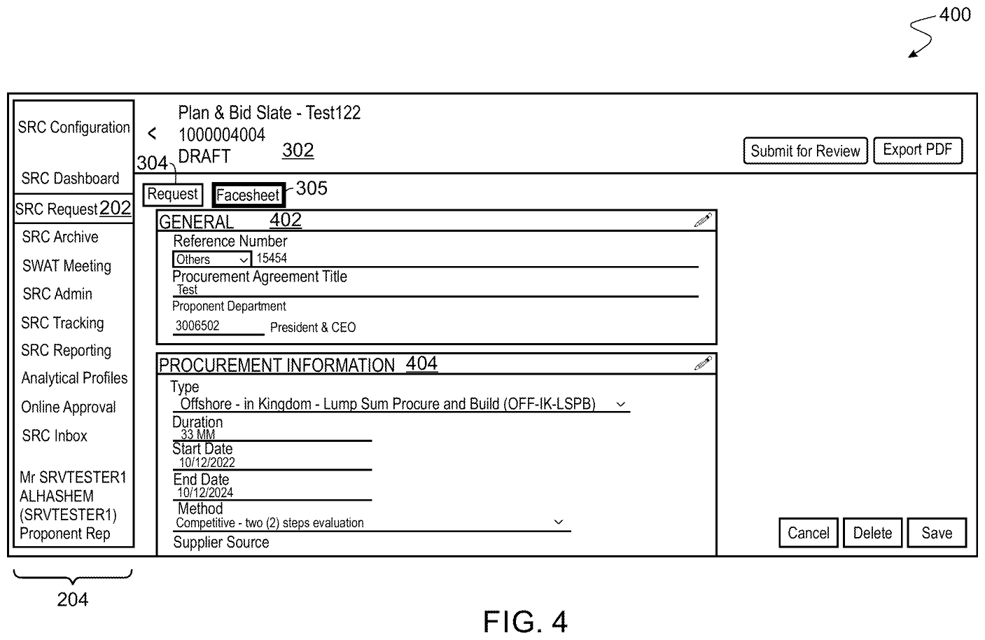

FIG. 4 is a screen print showing an example of a facesheet page 400, according to some implementations of the present disclosure. The face sheet page 400 can be displayed when the initiator selects the facesheet tab 305. The initiator can enter information in a general information area 402 and a procurement information area 404.

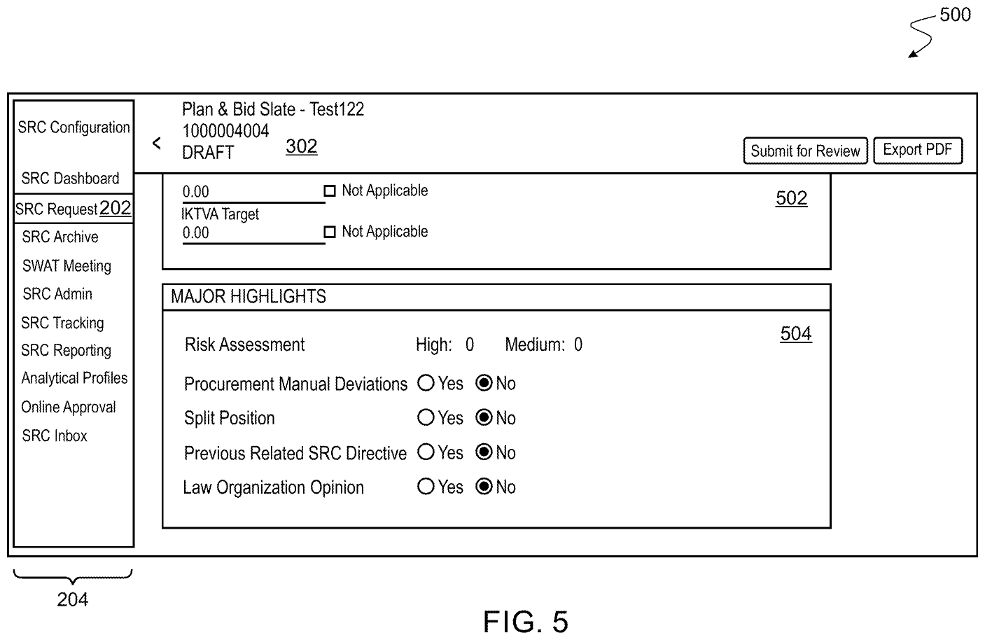

FIG. 5 is a screen print showing an example of a plan and bid slate 500, according to some implementations of the present disclosure. The plan and bid slate 500 can be displayed when the initiator starts a review/collaboration session and selects the users/reviewers/stakeholders to be invited/added to the session. System fields 502 and 504 can be filled by the initiator based on business-related data. The data can be reviewed and verified during the review session before routing for final approval and confirmed to be saved in the system and presented to the SRC members.

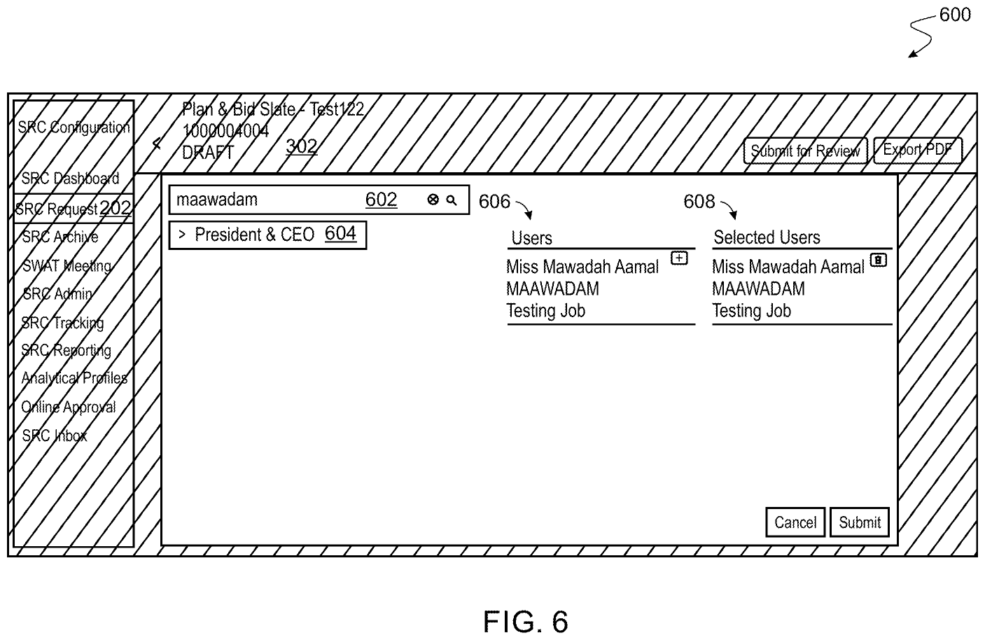

FIG. 6 is a screen print showing an example of a reviewer selection screen 600, according to some implementations of the present disclosure. Elements 602-608 can be used by the initiator to search for specific reviewers by username and to include comments/information displayed for that user. After that, the initiator can use element 608 to select this user to route review session to.

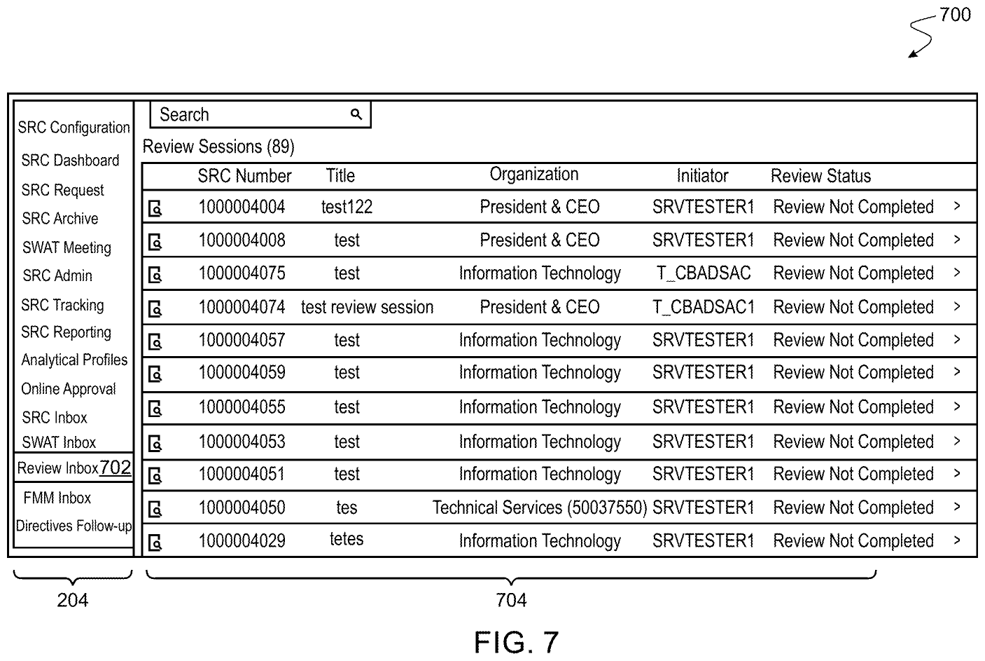

FIG. 7 is a screen print showing an example of a review session selection page 700, according to some implementations of the present disclosure. The review sessions selection page 700 can be displayed when the initiator selects the review inbox option 702, resulting in the display of active review sessions 704. For example, once a review/collaboration session is started, users/reviewers/stakeholders and the initiator can access a session 702 generated from the application review inbox

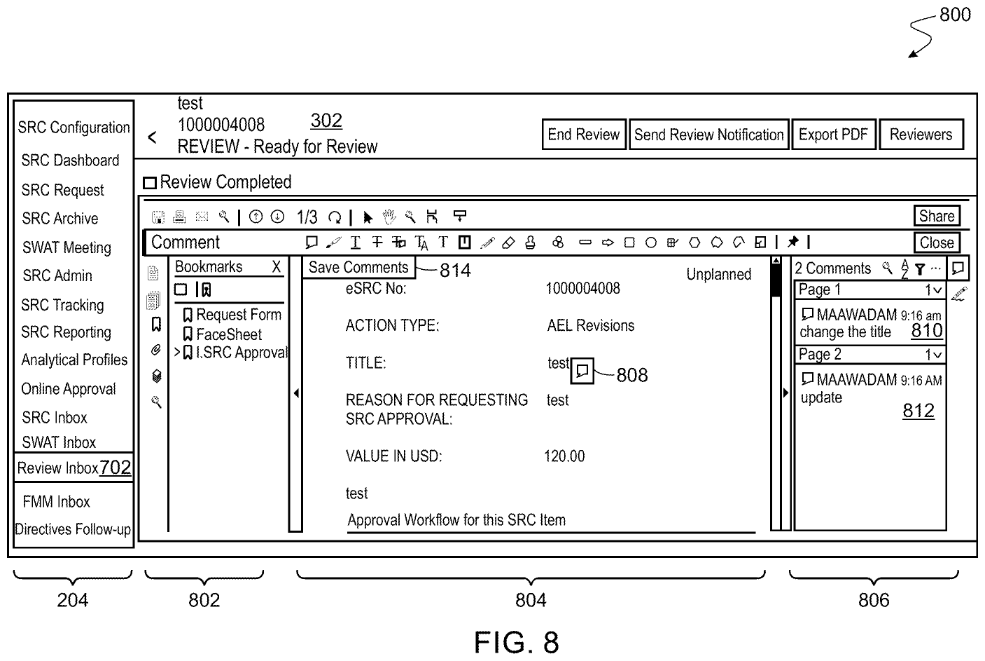

FIG. 8 is a screen print showing an example of a review session screen 800, according to some implementations of the present disclosure. In a review/collaboration session, the request/paper/form is transported/exported/presented in PDF format, where each PDF page presents one tab of the request/paper/form with bookmarks and watermarking. The review session screen 800 includes a document list area 802, a page display area 804, and a comments summary area 806.

During the review/collaboration session. All users are able to: 1) access the PDF file at the same time as other reviewers, 2) view the list of all reviewers, and 3) use all PDF annotation tools to comment on the PDF file. In the example shown in FIG. 8, page 1 of the document being reviewed is displayed. A reviewer's annotation 808 on page 1 of the document is further identified as an entry 810 in the comments summary area 806. An entry 812 identifies a reviewer comment on page 2 of the document.

When a reviewer would like to share/publish/release his comments to be visible/displayed/viewable to the other reviewers in this session, the reviewer can click on a Save Comments control 814 (e.g., a button allocated/placed inside the PDF file). Once (Save Comments) button is clicked, all comments/annotations entered by the user will be visible/displayed/viewable to the other reviewers in this session, instantly.

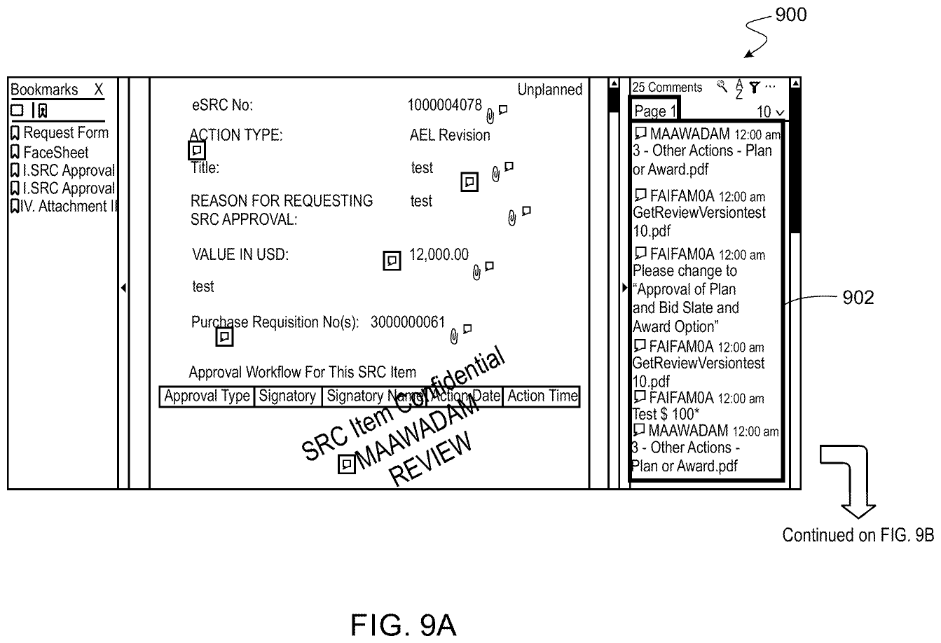

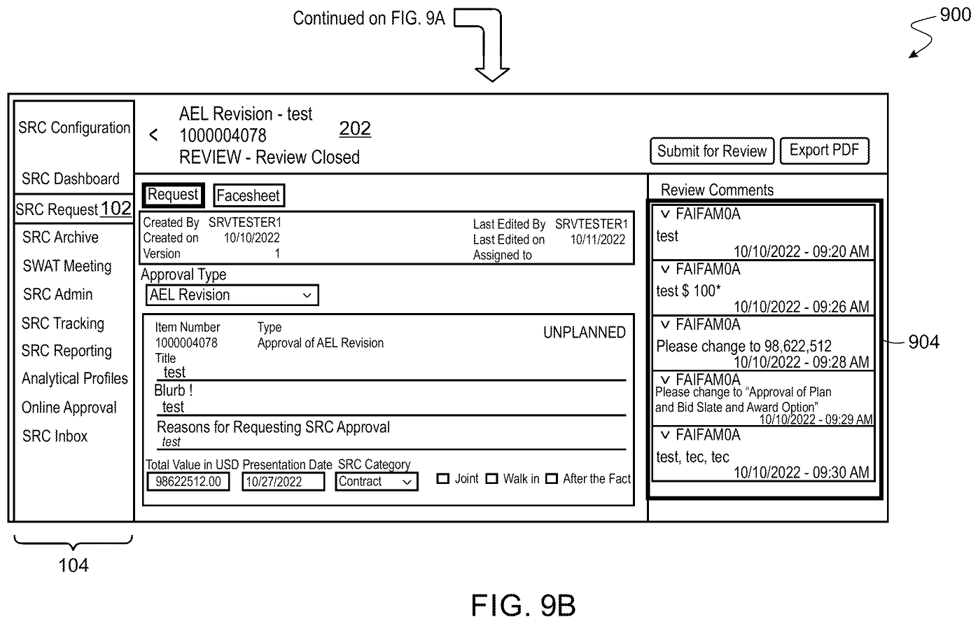

FIGS. 9A and 9B collectively show an example of collaboration session screen prints 900, according to some implementations of the present disclosure. For example, at the same time that comments are published to the reviewers in their review sessions (described with reference to FIG. 7), the comments are also published and made available for display to the initiator as shown in the collaboration session screen prints 900. Each comment from the PDF page (e.g., elements 706, 710, and 712) is included in a comments area 902. Each respective comment in the comments area 902 is linked/mapped in the request/paper/form/page and annotated with the reviewer's username, time, and date. For example, reviewer comments in the comments area 902 appear to the initiator in a comments area 904. The initiator is able to update the request/paper/form/page to reflect the comments from the PDF file without waiting for the review session to close and without referring back to the PDF file to see the comments. This result is possible because all the reviewers' comments are segregated on a per request/paper/form/page basis, making all comments available to the initiator in the comments area 904, essentially in real time. The term real-time can correspond, for example, to events that occur within a specified period of time, such as within one second.

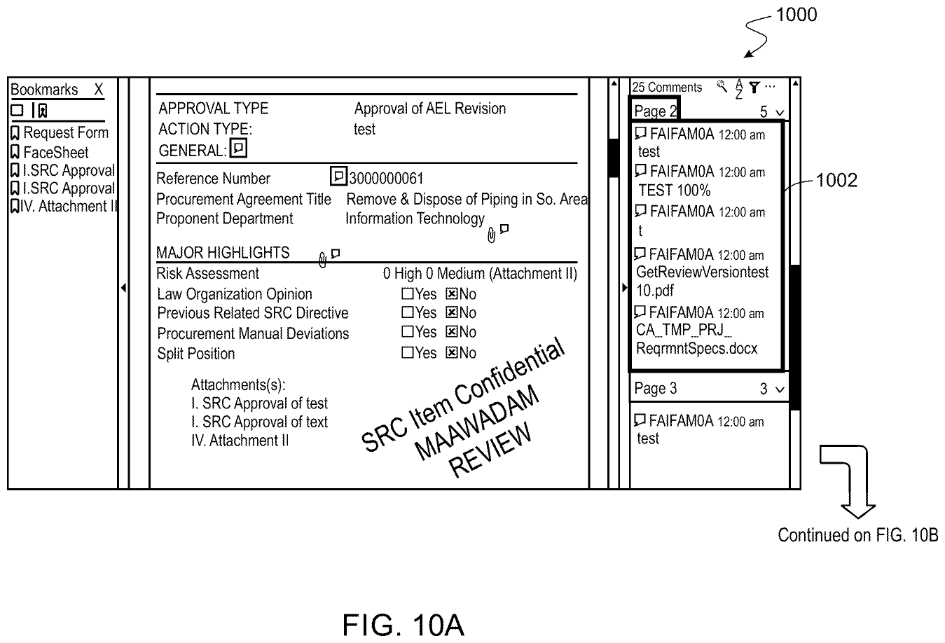

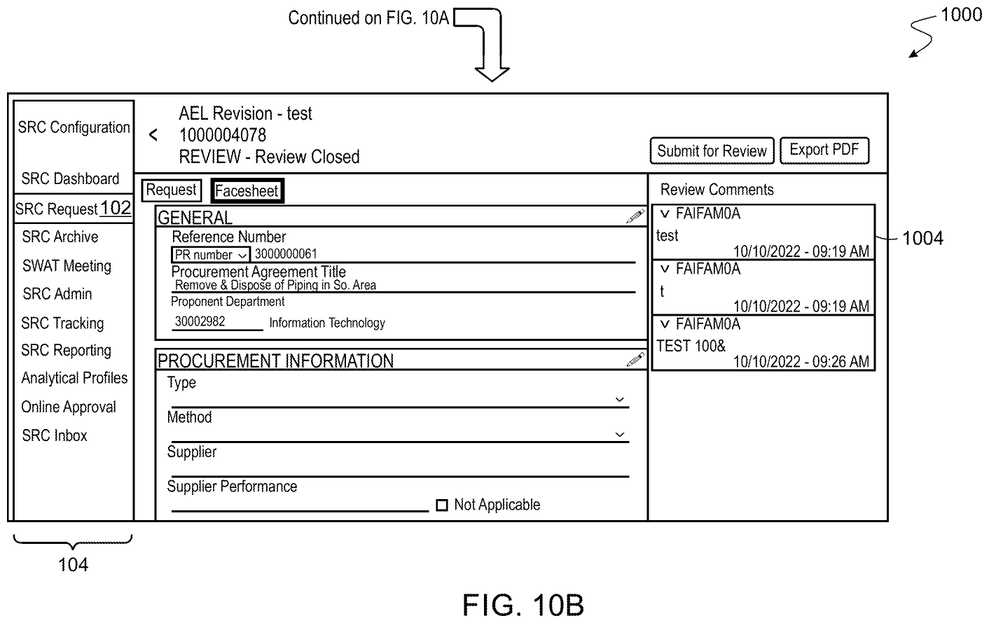

FIGS. 10A and 10B collectively show an example of collaboration session screen prints 1000, according to some implementations of the present disclosure. Each respective comment in the comments area 1002 is linked/mapped in the request/paper/form/page and annotated with the reviewer's username, time, and date. For example, reviewer comments in the comments area 1002 appear to the initiator in a comments area 1004. This is similar to FIG. 9A and FIG. 9B, but for page 2 of the source document.

Once a review session is closed by the initiator, the PDF file/version from the review session is available to the initiator with the comments from all reviewers as a reference for the positional tags and positional annotations. Multiple review sessions can be routed for different revisers at a time, and each review session can result in a PDF file/version and updated comments in the comments area 1004.

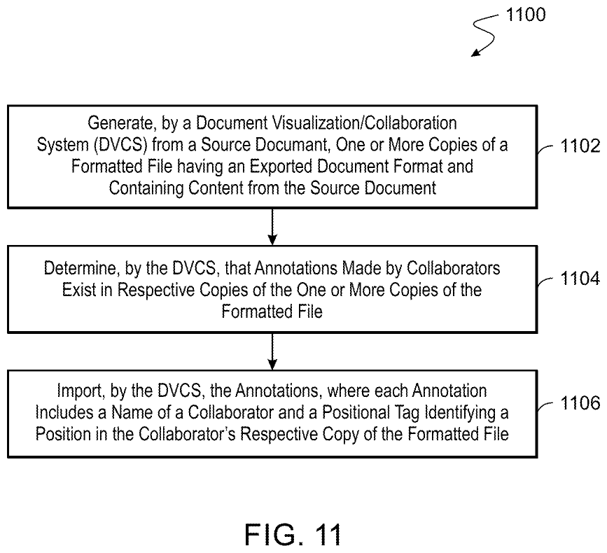

FIG. 11 is a flowchart of an example of a method 1100 for handling collaboration and providing visualizations of annotations in a formatted document linked to a source application, according to some implementations of the present disclosure. For clarity of presentation, the description that follows generally describes method 1100 in the context of the other figures (See FIGS. 1-10) in this description. However, it will be understood that method 1100 can be performed, for example, by any suitable system, environment, software, and hardware, or a combination of systems, environments, software, and hardware, as appropriate. In some implementations, various steps of method 1100 can be run in parallel, in combination, in loops, or in any order.

At 1102, one or more copies of a formatted file are generated by a document visualization/collaboration system (DVCS) from a source document (e.g., initiated by an initiator). Each copy has an exported document format and contains content from the source document. The formatted file can contain a watermark indicating a security level and an initiator name of an initiator of the source document. From 1102, method 1100 proceeds to 1104.

At 1104, a determination is made by the DVCS that annotations made by collaborators exist in respective copies of the one or more copies of the formatted file. From 1104, method 1100 proceeds to 1106.

At 1106, the annotations are imported by the DVCS. Each annotation includes a name of a collaborator and a positional tag identifying a position in the collaborator's respective copy of the formatted file. After 1106, method 1100 can stop.

In some implementations, method 1100 further includes displaying, by the DVCS for presentation in a user interface (U/I) and using the positional tags, the annotations in an area adjacent to a display of the source document, including displaying the name of the collaborator for each respective annotation. In some implementations, method 1100 further includes displaying, by the DVCS for presentation in the U/I and using the positional tags, the annotations in specific locations on the source document, including displaying the name of the collaborator for each respective annotation. In some implementations, method 1100 further includes: tracking, by the DVCS, the annotations made by a collaborator in their respective copy of the formatted file; receiving, by the DVCS from the collaborator, and indication to transmit the tracked annotations; and importing, by the DVCS in response to receiving the indication, the annotations made by the collaborator.

In some implementations, method 1100 further includes: receiving, by the DVCS through input into the U/I from an initiator of the source document, a list of collaborators to whom copies of the formatted file are to be transmitted; and transmitting, by the DVCS, the one or more copies of the formatted file to collaborators in the list of collaborators.

In some implementations, method 1100 further includes: receiving, by the DVCS through input from a collaborator, a selection of a control to save tracked annotations; and transmitting, by the DVCS, the annotations to a presentation of the source document.

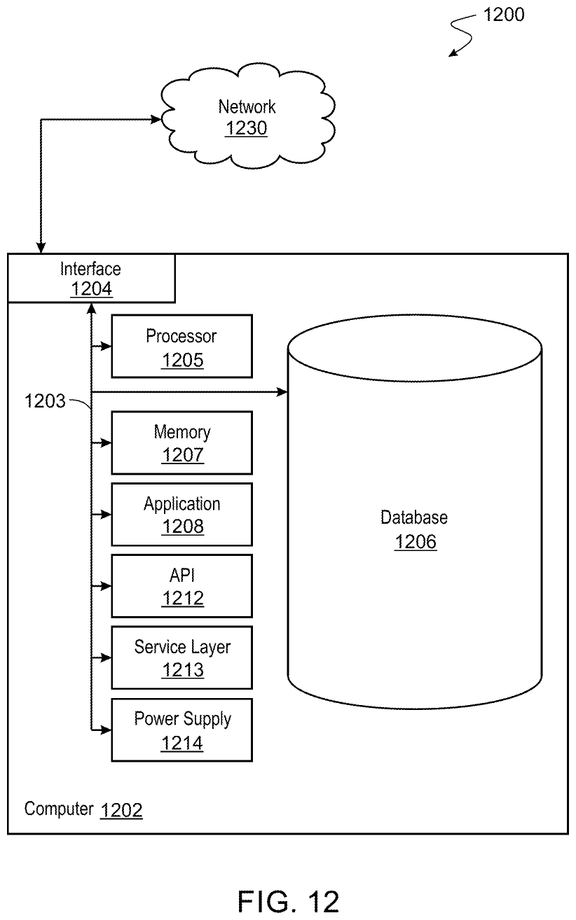

FIG. 12 is a block diagram of an example computer system 1200 used to provide computational functionalities associated with described algorithms, methods, functions, processes, flows, and procedures described in the present disclosure, according to some implementations of the present disclosure. The illustrated computer 1202 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1202 can include input devices such as keypads, keyboards, and touch screens that can accept user information. Also, the computer 1202 can include output devices that can convey information associated with the operation of the computer 1202. The information can include digital data, visual data, audio information, or a combination of information. The information can be presented in a graphical user interface (UI) (or GUI).

The computer 1202 can serve in a role as a client, a network component, a server, a database, a persistency, or components of a computer system for performing the subject matter described in the present disclosure. The illustrated computer 1202 is communicably coupled with a network 1230. In some implementations, one or more components of the computer 1202 can be configured to operate within different environments, including cloud-computing-based environments, local environments, global environments, and combinations of environments.

At a top level, the computer 1202 is an electronic computing device operable to receive, transmit, process, store, and manage data and information associated with the described subject matter. According to some implementations, the computer 1202 can also include, or be communicably coupled with, an application server, an email server, a web server, a caching server, a streaming data server, or a combination of servers.

The computer 1202 can receive requests over network 1230 from a client application (for example, executing on another computer 1202). The computer 1202 can respond to the received requests by processing the received requests using software applications. Requests can also be sent to the computer 1202 from internal users (for example, from a command console), external (or third) parties, automated applications, entities, individuals, systems, and computers.

Each of the components of the computer 1202 can communicate using a system bus 1203. In some implementations, any or all of the components of the computer 1202, including hardware or software components, can interface with each other or the interface 1204 (or a combination of both) over the system bus 1203. Interfaces can use an application programming interface (API) 1212, a service layer 1213, or a combination of the API 1212 and service layer 1213. The API 1212 can include specifications for routines, data structures, and object classes. The API 1212 can be either computer-language independent or dependent. The API 1212 can refer to a complete interface, a single function, or a set of APIs.

The service layer 1213 can provide software services to the computer 1202 and other components (whether illustrated or not) that are communicably coupled to the computer 1202. The functionality of the computer 1202 can be accessible for all service consumers using this service layer. Software services, such as those provided by the service layer 1213, can provide reusable, defined functionalities through a defined interface. For example, the interface can be software written in JAVA, C++, or a language providing data in extensible markup language (XML) format. While illustrated as an integrated component of the computer 1202, in alternative implementations, the API 1212 or the service layer 1213 can be stand-alone components in relation to other components of the computer 1202 and other components communicably coupled to the computer 1202. Moreover, any or all parts of the API 1212 or the service layer 1213 can be implemented as child or sub-modules of another software module, enterprise application, or hardware module without departing from the scope of the present disclosure.

The computer 1202 includes an interface 1204. Although illustrated as a single interface 1204 in FIG. 12, two or more interfaces 1204 can be used according to particular needs, desires, or particular implementations of the computer 1202 and the described functionality. The interface 1204 can be used by the computer 1202 for communicating with other systems that are connected to the network 1230 (whether illustrated or not) in a distributed environment. Generally, the interface 1204 can include, or be implemented using, logic encoded in software or hardware (or a combination of software and hardware) operable to communicate with the network 1230. More specifically, the interface 1204 can include software supporting one or more communication protocols associated with communications. As such, the network 1230 or the interface's hardware can be operable to communicate physical signals within and outside of the illustrated computer 1202.

The computer 1202 includes a processor 1205. Although illustrated as a single processor 1205 in FIG. 12, two or more processors 1205 can be used according to particular needs, desires, or particular implementations of the computer 1202 and the described functionality. Generally, the processor 1205 can execute instructions and can manipulate data to perform the operations of the computer 1202, including operations using algorithms, methods, functions, processes, flows, and procedures as described in the present disclosure.

The computer 1202 also includes a database 1206 that can hold data for the computer 1202 and other components connected to the network 1230 (whether illustrated or not). For example, database 1206 can be an in-memory, conventional, or a database storing data consistent with the present disclosure. In some implementations, database 1206 can be a combination of two or more different database types (for example, hybrid in-memory and conventional databases) according to particular needs, desires, or particular implementations of the computer 1202 and the described functionality. Although illustrated as a single database 1206 in FIG. 12, two or more databases (of the same, different, or combination of types) can be used according to particular needs, desires, or particular implementations of the computer 1202 and the described functionality. While database 1206 is illustrated as an internal component of the computer 1202, in alternative implementations, database 1206 can be external to the computer 1202.

The computer 1202 also includes a memory 1207 that can hold data for the computer 1202 or a combination of components connected to the network 1230 (whether illustrated or not). Memory 1207 can store any data consistent with the present disclosure. In some implementations, memory 1207 can be a combination of two or more different types of memory (for example, a combination of semiconductor and magnetic storage) according to particular needs, desires, or particular implementations of the computer 1202 and the described functionality. Although illustrated as a single memory 1207 in FIG. 12, two or more memories 1207 (of the same, different, or combination of types) can be used according to particular needs, desires, or particular implementations of the computer 1202 and the described functionality. While memory 1207 is illustrated as an internal component of the computer 1202, in alternative implementations, memory 1207 can be external to the computer 1202.

The application 1208 can be an algorithmic software engine providing functionality according to particular needs, desires, or particular implementations of the computer 1202 and the described functionality. For example, application 1208 can serve as one or more components, modules, or applications. Further, although illustrated as a single application 1208, the application 1208 can be implemented as multiple applications 1208 on the computer 1202. In addition, although illustrated as internal to the computer 1202, in alternative implementations, the application 1208 can be external to the computer 1202.

The computer 1202 can also include a power supply 1214. The power supply 1214 can include a rechargeable or non-rechargeable battery that can be configured to be either user- or non-user-replaceable. In some implementations, the power supply 1214 can include power-conversion and management circuits, including recharging, standby, and power management functionalities. In some implementations, the power supply 1214 can include a power plug to allow the computer 1202 to be plugged into a wall socket or a power source to, for example, power the computer 1202 or recharge a rechargeable battery.

There can be any number of computers 1202 associated with, or external to, a computer system containing computer 1202, with each computer 1202 communicating over network 1230. Further, the terms “client,” “user,” and other appropriate terminology can be used interchangeably, as appropriate, without departing from the scope of the present disclosure. Moreover, the present disclosure contemplates that many users can use one computer 1202 and one user can use multiple computers 1202.

Described implementations of the subject matter can include one or more features, alone or in combination.

For example, in a first implementation, a computer-implemented method includes the following. One or more copies of a formatted file are generated by a document visualization/collaboration system (DVCS) from a source document. Each copy has an exported document format and contains content from the source document. A determination is made by the DVCS that annotations made by collaborators exist in respective copies of the one or more copies of the formatted file. The annotations are imported by the DVCS. Each annotation includes a name of a collaborator and a positional tag identifying a position in the collaborator's respective copy of the formatted file.

The foregoing and other described implementations can each, optionally, include one or more of the following features:

A first feature, combinable with any of the following features, where the method further includes displaying, by the DVCS for presentation in a user interface (U/I) and using the positional tags, the annotations in an area adjacent to a display of the source document, including displaying the name of the collaborator for each respective annotation.

A second feature, combinable with any of the previous or following features, where the method further includes displaying, by the DVCS for presentation in the U/I and using the positional tags, the annotations in specific locations on the source document, including displaying the name of the collaborator for each respective annotation.

A third feature, combinable with any of the previous or following features, where the method further includes: tracking, by the DVCS, the annotations made by a collaborator in their respective copy of the formatted file; receiving, by the DVCS from the collaborator, and indication to transmit the tracked annotations; and importing, by the DVCS in response to receiving the indication, the annotations made by the collaborator.

A fourth feature, combinable with any of the previous or following features, where the method further includes: receiving, by the DVCS through input into the U/I from an initiator of the source document, a list of collaborators to whom copies of the formatted file are to be transmitted; and transmitting, by the DVCS, the one or more copies of the formatted file to collaborators in the list of collaborators.

A fifth feature, combinable with any of the previous or following features, where the method further includes: receiving, by the DVCS though input from a collaborator, a selection of a control to save tracked annotations; and transmitting, by the DVCS, the annotations to a presentation of the source document.

A sixth feature, combinable with any of the previous or following features, where the formatted file contains a watermark indicating a security level and an initiator name of an initiator of the source document.

A seventh feature, combinable with any of the previous or following features, where the source file is initiated by an initiator.

In a second implementation, a computer-implemented system includes one or more processors and a non-transitory computer-readable storage medium coupled to the one or more processors and storing programming instructions for execution by the one or more processors. The programming instructions instruct the one or more processors to perform operations including the following. One or more copies of a formatted file are generated by a document visualization/collaboration system (DVCS) from a source document. Each copy has an exported document format and contains content from the source document. A determination is made by the DVCS that annotations made by collaborators exist in respective copies of the one or more copies of the formatted file. The annotations are imported by the DVCS. Each annotation includes a name of a collaborator and a positional tag identifying a position in the collaborator's respective copy of the formatted file.

The foregoing and other described implementations can each, optionally, include one or more of the following features:

A second feature, combinable with any of the previous or following features, where the method further includes displaying, by the DVCS for presentation in the U/I and using the positional tags, the annotations in specific locations on the source document, including displaying the name of the collaborator for each respective annotation.

A third feature, combinable with any of the previous or following features, where the method further includes: tracking, by the DVCS, the annotations made by a collaborator in their respective copy of the formatted file; receiving, by the DVCS from the collaborator, and indication to transmit the tracked annotations; and importing, by the DVCS in response to receiving the indication, the annotations made by the collaborator.

A fourth feature, combinable with any of the previous or following features, where the method further includes: receiving, by the DVCS through input into the U/I from an initiator of the source document, a list of collaborators to whom copies of the formatted file are to be transmitted; and transmitting, by the DVCS, the one or more copies of the formatted file to collaborators in the list of collaborators.

A fifth feature, combinable with any of the previous or following features, where the method further includes: receiving, by the DVCS though input from a collaborator, a selection of a control to save tracked annotations; and transmitting, by the DVCS, the annotations to a presentation of the source document.

A sixth feature, combinable with any of the previous or following features, where the formatted file contains a watermark indicating a security level and an initiator name of an initiator of the source document.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at the application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together into a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

1. A computer-implemented method, comprising:
generating, by a document visualization and collaboration system (DVCS) from a source document associated with a request of a plurality of requests, the source document being accessed at a same time by collaborators, one or more copies of a formatted file having an exported document format and containing content from the source document;
determining, in real time by the DVCS, that annotations being made by the collaborators at the same time exist in respective copies of the one or more copies of a formatted file;
importing, in real time by the DVCS from a plurality of computing devices of the collaborators, the annotations, wherein each annotation comprises a name of a collaborator and a positional tag identifying a position in a collaborator's respective copy of the formatted file being accessed at the same time;
providing, in real time by the DVCS, for display a collaboration session screen comprising the collaborator's respective copy of the formatted file overlaid with the annotations imported in real time, during a review session, before the review session closes;
determining, by the DVCS, a completion of the request based on one or more actions performed on the formatted file; and
automatically cycling by the DVCS, the requests to new statuses.

2. The computer-implemented method of claim 1, further comprising:
displaying, by the DVCS for presentation in a user interface (U/I) and using positional tags, the annotations in an area adjacent to a display of the source document, comprising displaying the name of a collaborator for each respective annotation.

3. The computer-implemented method of claim 2, further comprising:
displaying, by the DVCS for presentation in the U/I and using the positional tags, the annotations in specific locations on the source document, comprising displaying the name of a collaborator for each respective annotation.

4. The computer-implemented method of claim 1, further comprising:
tracking, by the DVCS and as tracked annotations, the annotations made by a collaborator in their respective copy of the formatted file;
receiving, by the DVCS from the collaborator, an indication to transmit the tracked annotations; and
importing, by the DVCS in response to receiving the indication, the annotations made by the collaborator.

5. The computer-implemented method of claim 3, further comprising:
receiving, by the DVCS through input into the U/I from an initiator of the source document, a list of collaborators to whom copies of the formatted file are to be transmitted; and
transmitting, by the DVCS, the one or more copies of the formatted file to collaborators in the list of collaborators.

6. The computer-implemented method of claim 3, further comprising:
receiving, by the DVCS though input from a collaborator, a selection of a control to save tracked annotations; and
transmitting, by the DVCS, the annotations to a presentation of the source document.

7. The computer-implemented method of claim 1, wherein the formatted file contains a watermark indicating a security level and an initiator name of an initiator of the source document.

8. The computer-implemented method of claim 1, wherein the source document is initiated by an initiator.

9. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
generating, by a document visualization and collaboration system (DVCS) from a source document associated with a request of a plurality of requests, the source document being accessed at a same time by collaborators, one or more copies of a formatted file having an exported document format and containing content from the source document;
determining, in real time by the DVCS, that annotations being made by the collaborators at the same time exist in respective copies of the one or more copies of a formatted file;
importing, in real time by the DVCS from a plurality of computing devices of the collaborators, the annotations, wherein each annotation comprises a name of a collaborator and a positional tag identifying a position in a collaborator's respective copy of the formatted file being accessed at the same time;
providing, in real time by the DVCS, for display a collaboration session screen comprising the collaborator's respective copy of the formatted file overlaid with the annotations imported in real time, during a review session, before the review session closes;
determining, by the DVCS, a completion of the request based on one or more actions performed on the formatted file; and
automatically cycling, by the DVCS, the requests to new statuses.

10. The computer-implemented system of claim 9, further comprising:
displaying, by the DVCS for presentation in a user interface (U/I) and using positional tags, the annotations in an area adjacent to a display of the source document, comprising displaying the name of a collaborator for each respective annotation.

11. The computer-implemented system of claim 10, further comprising:
displaying, by the DVCS for presentation in the U/I and using the positional tags, the annotations in specific locations on the source document, comprising displaying the name of a collaborator for each respective annotation.

12. The computer-implemented system of claim 9, further comprising:
tracking, by the DVCS and as tracked annotations, the annotations made by a collaborator in their respective copy of the formatted file;
receiving, by the DVCS from the collaborator, an indication to transmit the tracked annotations; and
importing, by the DVCS in response to receiving the indication, the annotations made by the collaborator.

13. The computer-implemented system of claim 11, further comprising:
receiving, by the DVCS through input into the U/I from an initiator of the source document, a list of collaborators to whom copies of the formatted file are to be transmitted; and
transmitting, by the DVCS, the one or more copies of the formatted file to collaborators in the list of collaborators.

14. The computer-implemented system of claim 11, further comprising:
receiving, by the DVCS though input from a collaborator, a selection of a control to save tracked annotations; and
transmitting, by the DVCS, the annotations to a presentation of the source document.

15. The computer-implemented system of claim 9, wherein the formatted file contains a watermark indicating a security level and an initiator name of an initiator of the source document.
